(19) United States
(12) Patent Application Publication
(10) Pub. No.: US 2025/0207504 A1
(43) Pub. Date: Jun. 26, 2025

(54) Cartridge for Inlet Seal and Liner

(71) Applicant: Whisper Aero Inc., Crossville, TN (US)

(72) Inventors: Matthew Alan Dempsey, Nashville, TN (US); Colton Reed Johnson, Schenectady, NY (US); Andy Le, Garden Grove, CA (US); Gabriel L. Suciu, Glastonbury, CT (US)

(21) Appl. No.: 18/988,123

(22) Filed: Dec. 19, 2024

Related U.S. Application Data
(60) Provisional application No. 63/612,994, filed on Dec. 20, 2023.

(51) Int. Cl. F01D 11/08; F01D 25/26; F04D 29/66

(52) U.S. Cl. CPC F01D 11/08; F01D 25/26; F04D 29/663; F05D 2220/32; F05D 2240/14; F05D 2240/55; F05D 2260/96

(57) ABSTRACT

Aspects of the disclosure relate to a ducted propulsor fan having a modular duct. The modular duct may include a front inlet liner that can be easily removed from the ducted propulsor fan. The removable front inlet liner may allow for servicing of a fan seal included in the ducted propulsor fan. The ducted propulsor fan may be configured to be compatible with different front inlet liners that each have different acoustic properties.

### CROSS REFERENCE TO RELATED APPLICATION

This application claims priority to U.S. Provisional Patent Application No. 63/612,994 entitled “Removable Inlet Liner for Propulsor” and filed on Dec. 20, 2023, which is incorporated by reference in its entirety herein for any and all non-limiting purposes.

### TECHNICAL FIELD

The present disclosure generally relates to propulsor fan systems, and more particularly to modular cartridges for inlet seals and liners of propulsor fan system that provide enhanced fan assembly and ease of maintenance as well as improved acoustics and performance characteristics.

### BACKGROUND

Ducted propulsor fan systems often require ongoing maintenance of internal components, such as the fan seal. For example, typical turbo engines require the fan seal to be replaced every 1,000 to 10,000 hours. However, maintenance of the conventional ducted propulsor fans can require disassembly of a majority of the ducted propulsor fan to access the fan seal. Thus, the maintenance of the conventional ducted propulsor fan is time consuming.

Accordingly, aspects of the present disclosure described herein may address one or more problems of improving and adapting issues with accessing and maintaining internal component of ducted propulsor fan system. Aspects of this disclosure address the above and/or other needs in the art.

### SUMMARY

The following presents a simplified summary of various aspects described herein. This summary is not an extensive overview and is not intended to identify key or critical elements or to delineate the scope of any claim. The following summary merely presents some concepts in a simplified form as an introductory prelude to the more detailed description provided below.

Aspects described herein relate to systems that may include a cartridge for an inlet seal and acoustic liner that may provide enhanced fan assembly and ease of maintenance. The cartridge may include a modular duct with a front inlet portion configured for easy removal from a fan assembly, thus providing ease of access to the fan, seal, and other assembly components, such as the motor, the stator, and the like. The cartridge may be sized and dimensioned such that, when assembled with the inlet seal and acoustic liner, a controlled gap seal forms between the cartridge and the acoustic liner, that reduces or minimizes rotor tip leakage in the duct, thereby reducing noise and increasing efficiency of the fan assembly. The seal may by formed of a consumable and may be configured for easy replacement over time as the seal wears during use. The duct may be configured as a modular component capable of easy removal from the fan assembly for the maintenance or assembly of new acoustic liner in the forward duct portion. Accordingly, aspects of the present disclosure allow for ease of servicing the seal and other components of the fan assembly as well as improving acoustics and efficiency of the fan assembly and providing a modular design that allows for swapping different liners and/or forward duct geometries in a given fan assembly, e.g., to achieve improved performance and acoustics.

Some aspects described herein may include a ducted propulsor fan having a modular duct. The modular duct may include a front inlet liner that can be easily removed from the ducted propulsor fan. The removable front inlet liner allows for easy access to components of the propulsor fan such as a fan, fan seal, motor, stator, and other components of the propulsor fan.

In some examples, the modular duct may be configured to be connectable to different removable front inlet liners that may each have different characteristics. Thus, the modular duct may be configured with a particular removable inlet that satisfies operation specifications of a particular propulsor fan, such as a particular sound emission specification.

A ducted propulsor fan may include a duct extending from a first end to a second end, a first liner configured to be movably installed at the first end of the duct, a second liner proximate to the second end of the duct, a fan positioned between the first liner and the second liner, wherein the fan is concentric with the first liner and the second liner, a seal positioned radially around an outer diameter of the fan and located between the first liner and the second liner. Removal of the first liner may enable access to the seal from the first end of the duct.

In some instances, the seal may be bonded with the first liner or with the aft liner, such that the seal and the respective bond liner form an integral piece that can be removed and replaced in maintaining the propulsor system. In some instances, a third liner may be included between the first liner and the second liner, in which the seal may be bonded to the seal ring. Accordingly, in replacing a seal during maintenance of the propulsor system, the first liner may be removed to access and replace the seal and seal ring, and then the first liner may be replaced in position in the duct.

A cartridge for a propulsor fan may include an aft liner configured for placement in an aft end of a fan duct of the propulsor fan, a forward liner configured for placement in a forward end of the fan duct of the propulsor fan, and a seal positioned between the forward liner and the aft liner and facing an outer diameter of a fan of the fan propulsor. Removal of the forward liner may enable access to the seal from the first end of the duct.

These features, along with many others, are discussed by way of example in greater detail below. Corresponding systems and methods are also within the scope of the disclosure.

### BRIEF DESCRIPTION OF THE DRAWINGS

The present disclosure is illustrated by way of example and not limited in the accompanying figures in which like reference numerals indicate similar elements and in which:

FIG. 1 illustrates a cross-section view of a ducted propulsor fan having a modular duct according to one or more examples as described herein.

FIGS. 2A, 2B, and 2C respectively illustrate a front view, a side view, and a perspective view of a front inlet liner of a modular duct according to one or more examples as described herein.

FIG. 3 illustrates a cross-section view of a front inlet liner of a modular duct according to one or more examples as described herein.

FIG. 4A illustrates a cross-section view of a ducted propulsor fan with a front inlet liner according to one example as described herein.

FIG. 4B illustrates a cross-section view of a ducted propulsor fan and the removal of a front inlet liner according to one or more examples as described herein.

FIG. 4C illustrates a cross-section view of a ducted propulsor fan with a front inlet liner removed according to one or more examples as described herein.

FIG. 5 illustrates a cross-section view of a ducted propulsor fan with a two-part modular ducted liner according to one or more examples as described herein.

FIG. 6 illustrates a cross-section view of a ducted propulsor fan with a three-part modular ducted liner according to one or more examples as described herein.

FIG. 7 illustrates a cross-section view of a ducted propulsor fan with another two-part modular ducted liner according to one or more examples as described herein.

FIGS. 8A-8C illustrate cross-section views of a two-part modular ducted liner, a three-part modular ducted liner, and another two-part modular ducted liner, respectively, each mounted in a ducted propulsor fan according to one or more examples as described herein.

FIG. 9 illustrates an example flow chart for performing maintenance on a ducted propulsor fan with a modular duct and liner cartridge according to one or more examples as described herein.

### DETAILED DESCRIPTION

In the following description, reference is made to the accompanying drawings, which form a part hereof, and in which is shown by way of illustration various examples in which the disclosure may be practiced. It is to be understood that other examples may be utilized and implemented whereby structural and functional modifications may be made without departing from the scope and spirit of the present disclosure. Further, headings within this disclosure should not be considered as limiting aspects of the disclosure. Those skilled in the art with the benefit of this disclosure will appreciate that the examples are not limited to the headings.

Aspects of the disclosure are capable of other embodiments and of being practiced or being carried out in various ways. Also, it is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof. The terms “outlet” and “exhaust” and “nozzle” may also be used interchangeably. The terms “propulsor system” and “propulsor fan” and “propulsor fan and drive system” are also used interchangeably.

By way of introduction, aspects discussed herein may relate to ducted propulsor fan systems and methods to perform maintenance of components of ducted propulsor systems. For example, such propulsor fans may be used to power an aircraft. Such propulsor fans may require ongoing servicing and maintenance, including accessing internal components of the fan propulsor, which may be accomplished more efficiently and effectively than prior systems and methods.

### Propulsor Fan and Drive Systems

According to aspects described herein, a propulsor fan and drive system (also referred to herein as a propulsor fan system or a propulsor fan) is described herein. Generally, the propulsor fan and drive system is configured to generate thrust. The propulsor fan and drive system may generate thrust for various applications from aircraft to hand tools such as a leaf blower, hair dryer, and vacuum. The propulsor fan and drive fan may be used in other applications such as fans in server farms for cooling where the fans are rack mounted or roof mounted. The propulsor fan and drive system may also be used in automobiles to reduce noise. However, the applications of the propulsor fan and drive system are not limited those described herein.

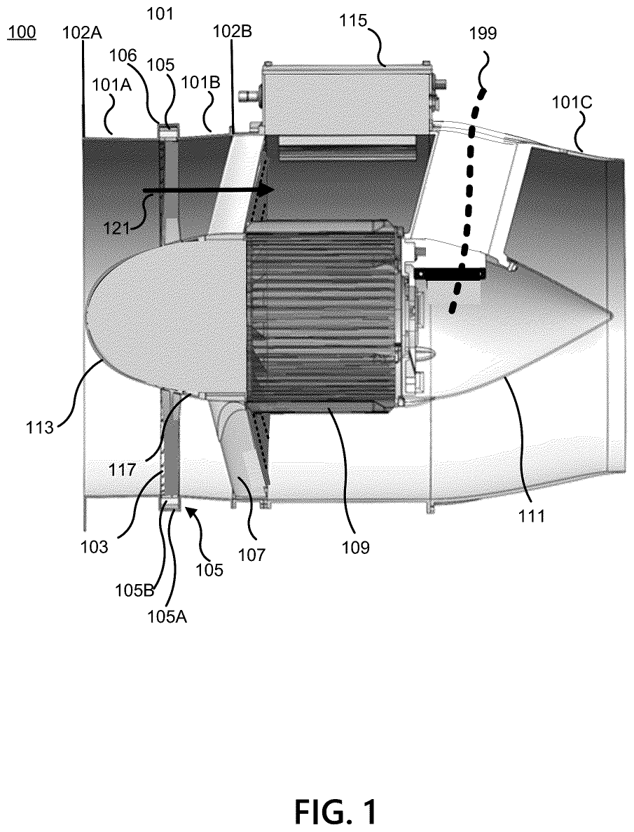

FIG. 1 illustrates a cross-section view of a ducted propulsor fan 100 (herein referred to as a “propulsor fan 100”) according to one or more examples. The propulsor fan 100 may include a modular duct 101. A front inlet liner 101A of the modular duct may be removable to allow for easier servicing of the propulsor fan 100 compared to conventional propulsor fans. The modular duct 101 may also be configured to be compatible with different front inlet liners that each have different characteristics, as will be further described below.

In some examples, the propulsor fan 100 may include a modular duct 101, a bladed fan 103, a fan seal 105, a stator 107, a motor 109, a tail cone 111, a nose cone 113, and an electronic speed controller unit 115. As seen in FIG. 1, wiring 199 may extend into the modular duct 101 for connecting to the motor. The stator 107 includes multiple stator vanes. The quantity and arrangement of the stator vanes may vary in different embodiments, which is conveyed throughout the figures by using dashed lines for example stator vanes. Other examples of the propulsor fan 100 may include other components than shown in FIG. 1.

In some examples, the modular duct 101 may include a plurality of panels that collectively form the modular duct. For example, the modular duct 101 may include a first plurality of panels that collectively form an inner surface of the modular duct 101 and include a second plurality of panels that collectively form an outer surface of the modular duct 101 such that the modular duct 101 has a hollow center through which air is channeled to the bladed fan 103. The first and second plurality of panels may be connected to each other via various fastening means such as fasteners (e.g., screws, nuts, bolts) or via welding. The first and second plurality of panels may be made of metal such as aluminum or titanium or composite such as carbon fiber. Alternatively, the modular duct 101 may be made using a single piece of material and may be 3D printed for example. Still further, the modular duct 101 may include a plurality of liners in an axial direction, as will be described in more detail below.

Modular duct 101 may include a front inlet liner 101A (also referred to as a first liner or a forward liner) at a first end (e.g., a forward end) of the modular duct 101, an intermediate liner 101B (also referred to as a second liner or an aft liner) at a second end (e.g., an aft end) of the modular duct 101, and an aft structure 101C. The intermediate liner 101B may be located at an end, e.g., an aft end, of the front inlet liner 101A and may be located between the front inlet liner 101A and the aft structure 101C. The aft structure 101C may include an exhaust of the propulsor fan 100. As shown in FIG. 1, the aft structure 101C may be connected to an end, e.g., an aft end, of the intermediate liner 101B and may taper inward towards the aft end of the propulsor fan 100.

According to one or more examples, propulsor fan 100 includes a modular duct 101 extending from a first end 102A to a second end 102B. A first liner or front inlet liner 101A may be configured to be removably installed at the first end 102A of the modular duct 101, a second liner or aft liner 101B proximate to the second end 102B of the modular duct 101, a bladed fan 103 positioned between the first liner or front inlet liner 101A and the second liner or aft liner 101B. The bladed fan 103 may be positioned concentric with the first liner 101A and the second liner 101B. A fan seal 105 may be positioned radially around the bladed fan 103 (e.g., the fan seal 1-5 may be disposed along an outer circumference of the bladed fan 103) and located between the first liner 101A and the second liner 101B, such that removal of the first liner 101A enables access to the fan seal 105 from the first end 102A of the modular duct 101.

The front inlet liner 101A may be configured to provide a clean inflow of air to the propulsor fan 100. The front inlet liner 101A may form an inner liner of the modular duct 101 and may be non-structural. The front inlet liner 101A may be removable from an inner cavity of the modular duct 101 to allow for different front inlet liners to be installed in the modular duct 101. In that regard, the propulsor fan 100 may be configured to receive a plurality of different front inlet liners that may each have different structural characteristics. For example, a customer may want a propulsor fan with a smaller intake diameter than a current configuration of the propulsor fan 100. Thus, a front inlet liner having a smaller intake diameter than the currently installed front inlet liner 101A can be installed into the modular duct 101 without modifying the duct itself. Accordingly, the modular duct 101 is compatible with a plurality of different front inlet liners.

The modular duct 101 may be configured to connect to a body of the propulsor fan 100 in any number of suitable manners. For example, the modular duct 101 may include a plurality of mounting holes proximate to the second end 102B of the modular duct 101. Fasteners (e.g., nuts and bolts, rivets, etc.) may be placed in the mounting holes to connect the modular duct 101 to the body of the propulsor fan 100 as will be further described below.

In some examples, a plurality of mounting holes may be formed around the circumference of the fan propulsor to connect the modular duct 101 thereto. For example, the modular duct 101 may be configured to connect to an end (e.g., an inlet) proximate to the stator 107. Mounting holes at an end of the fan propulsor 100 may be aligned with mounting holes on the second end 102B of the modular duct 101. Fasteners (e.g., nuts, bolts, rivets) may be used to secure the modular duct 101 to the propulsor fan, e.g., proximate to the stator 107.

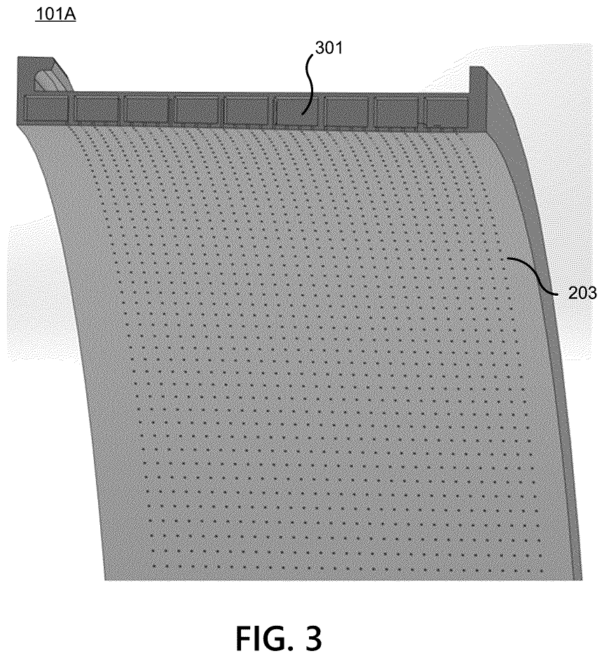

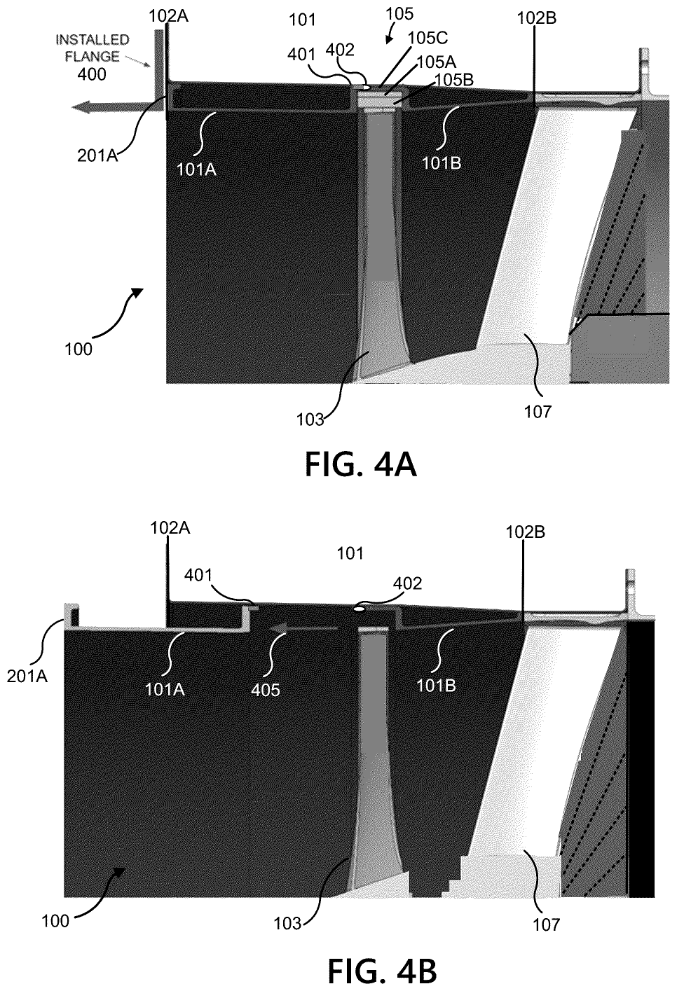

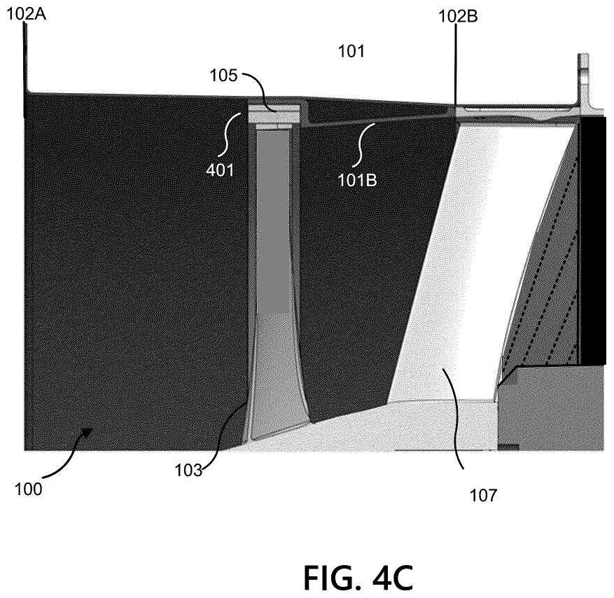

In certain examples, and as shown in FIGS. 4A and 4B, component of the modular duct 101, e.g., the first liner 101A, the second liner 101B, may include a plurality of tabs 401 and a plurality of slots 402 each configured to receive a respective tab. The plurality of tabs 401 and the plurality of slots 402 may be configured to releasably hold the first liner 101A in place in the modular duct 101. A fan seal (e.g., the fan seal 105) may releasably held in place using a similar tab and slot configuration. The first liner 101A and/or the second liner 101B may include a plurality of apertures and/or channels in a region surrounding a tip of the blade fan 103 to drain ingested water from an air flow path through the propulsor fan, e.g., including air flow from the primary flow path 121. As shown in FIG. 1, the primary flow path 121 may include a path through which air flows through the core of the propulsor fan 100, and may extend from an inlet, e.g., an axial location proximate to the first end 102A of the modular duct 101, around the nosecone 113, and through the blade fan 103 and stator 107. A semi-porous structure or a cellular structure may reside within one or more apertures of the plurality of apertures of the first liner 101A and/or the second liner 101B. The semi-porous structure or cellular structure may be configured to transfer fluid from the primary flow path.

As shown in FIG. 1, the first liner 101A may include a fan tip region 106 that extends over the outer diameter of the blade fan 103, and the fan tip region 106 has a larger diameter than a diameter of the first end 102A of the modular duct 101. In some examples, a third liner may additionally be provided between the first liner 101A and the second liner 101B, and the third liner may extend over the outer diameter of the blade fan 103 with respect to a cross-sectional plan along a length of the duct from the first liner 101A to the second liner 101B, e.g., with the fan tip region 106 forming the third liner.

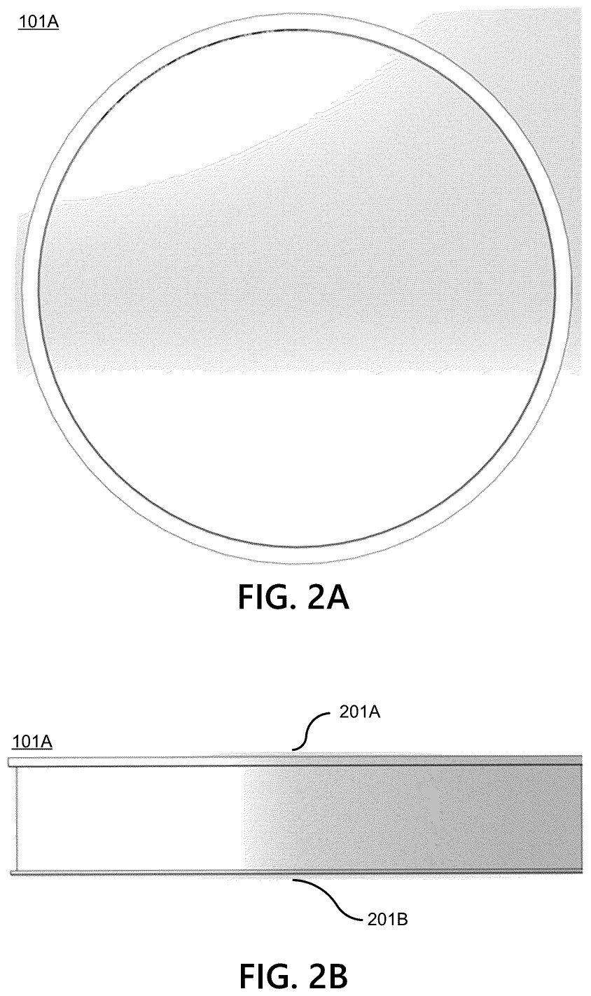

FIGS. 2A, 2B, and 2C respectively show a front view, a side view, and a perspective view of a front inlet liner 101A of a modular duct 101 according to one or more examples. As will be further described below, the front inlet liner 101A may be configured to slide into an inner cavity of the modular duct 101. As shown in FIGS. 2A and 2C, the front inlet liner 101A may be circular in shape with a cavity formed through a center, e.g., so as to form a cylindrical ring. The front inlet liner 101A may have a hoop shape that extends circumferentially around an inner diameter of the duct. Similarly, the intermediate liner 101B may have a hoop shape that extends circumferentially around an inner diameter of the duct. As shown in FIG. 2B, the front inlet liner 101A may have a first end 201A and a second end 201B. In some example, a diameter of the first end 201A may be larger than a diameter of the second end 201B. In some example, a diameter of the first end 201A may the same or substantially the same as a diameter of the second end 201B.

As shown in FIG. 2C, the front inlet liner 101A may include acoustic features 203, such as an acoustic liner configured to attenuate noise. Although the acoustic features 203 are shown in a portion of an inner surface of the front inlet liner 101A, the acoustic features 203 may be disposed differing portions of the inner surface, or along the entire inner surface of the front inlet liner 101A. In some examples, the acoustic features 230 may be included on a forward surface and/or a rear surface of the front inlet liner.

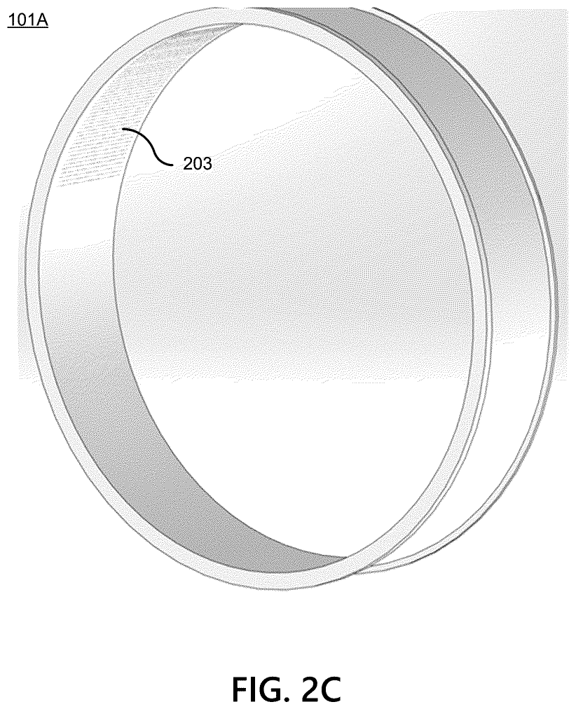

FIG. 3 illustrates a cross-section view of a front inlet liner 101A of a modular duct 101. In some examples, the acoustic features 203 may include a plurality of apertures that extend through a thickness of the inner surface of the front inlet liner 101A. The plurality of apertures of the acoustic features 203 may be provided in any number of suitable patterns or variations along a surface of the front inlet liner 101A to achieve desired acoustics in the duct. For example, as shown in FIG. 3 the plurality of apertures of the acoustic features 203 may be provided in a grid format. Still other patterns of the plurality of apertures may be provided in accordance with aspects of the present disclosure.

The front inlet liner 101A may also include a plurality of channels 301 formed within the front inlet liner 101A along a circumference of the front inlet liner 101A. The plurality of channels 301 may extend along the circumference of the front inlet liner 101A, and the channels 301 may extend parallel to each other. Each channel 301 may be hollow. Each of the acoustic features 203 may terminate at a corresponding channel 301. In some examples, the channels 301 may not be hollow and may include a cellular structure such as a honeycomb. The combination of the acoustic features 203 and the channels 301 may function to attenuate noise and improve the acoustics of a fan propulsor. For example, the acoustic features 203 may act as Helmholtz resonators to dissipate sound energy. The channels 301 may be designed to dissipate energy by matching the geometry of the channels to the wavelength of a specific frequency of sound that is being reduced. The geometry of the channels 301 may thus act to “trap” sound waves and as the waves bounce around inside the channels 301, and energy may then be dissipated into the air and walls of the channels 301 as heat energy.

Referring back to FIG. 1, the bladed fan 103 may include a plurality of blades. The total number of blades included in the bladed fan 103 may be significantly more than the number of blades included in conventional propulsor fans that have 2 to 5 blades. In some examples, the bladed fan 103 may include any number of blades, from a lower range of about 20 blades to an upper range of about 150 blades. The blade may have a hub/tip ratio (H/t) of 0.3 to 0.5. However, any number of blades, e.g., greater than five, may be used without departing from the scope of the instant disclosure. Similarly, the blades may have hub/tip ratios less than 0.3 or greater than 0.5, without departing from the scope of the present disclosure. Generally, the total number of blades included in the bladed fan 103 may be dependent on the application of the fan propulsor. The material for the blades may also be dependent on the type of application of the fan. For example, the blades may be composed of metal such as aluminum or titanium or a composite such as carbon fiber, or combinations thereof. One or more bladed fans may comprise a bladed disk, also called a blisk, as disclosed in U.S. patent application Ser. No. 18/891,746, filed Sep. 20, 2024 and/or U.S. patent Ser. No. 18/891,900, filed Sep. 20, 2024, both of which are hereby incorporated by reference in their entirety for any and all non-limiting purposes. In certain embodiments, fans having a high blade count are utilized. In such embodiments, because of the higher number of blades of the bladed fan 103, a more forward center of gravity results in the fan propulsor 100, which may allow for greater eases in centering and replacing components in the duct.

In some examples, the bladed fan 103 may reduce overall blade noise as the bladed fan 103 spins at a low tip speed (around 300-450 ft/sec). As described herein, the tensioned bladed fan blade 103 may allow for many more blades to be included within mechanical material limits and still achieve ultrasonic signatures and low subsonic tip speeds. Furthermore, a higher number of blades raises the tonal noise into ultrasonic frequencies outside the upper limit of human audibility (around 2-16,000 Hz for typical adults). Furthermore, a low blade loading due to the higher blade count may also reduce the severity of vortex-to-vortex collisions which cause broadband noise.

The bladed fan 103 may include a plurality of blades arranged to form a circular ring shape with a hollow center where a hub is disposed. Each blade may be positioned such that at least a portion of the leading edge and at least a portion of the trailing edge of the blade are overlapped by neighboring blades. For example, a leading edge of a given blade may be overlapped by the trailing edge of a blade to the left of the given blade and a trailing edge of the given blade may be overlapped by a leading edge of a blade to the right of the given blade.

Each blade may be comprised of an airfoil disposed between a first locking end and a second locking end. In some examples, the airfoil may have a geometric twist. The geometric twist may include a change in airfoil angle of incidence measured with respect to the root of the blade. That is, the airfoil may include a plurality of different angles of incidence across the length of the airfoil due to the geometric twist. For example, the airfoil may have a first angle of incidence at a first side of the geometric twist and may have a second angle of incidence at a second side of the geometric twist. U.S. Pat. No. 11,802,485, entitled “Propulsor Fan Array,” is incorporated by reference in its entirety herein, and describes example propulsor fans and bladed disks that may implement the inlet seal and liner concepts described herein.

In some examples, the fan seal 105 (e.g., a tip shroud) may be disposed along an outer circumference of the blade fan 103. The fan seal 105 may be configured to reduce rotor tip leakage in the modular duct 101, thereby reducing noise and increasing efficiency. The fan seal 105 may provide higher power efficiency for the fan propulsor 100 due to the fan seal 105 forcing the blade fan 103 to intake new air as opposed to recirculating air, which also increases thermal efficiency due to not recirculating air. The fan seal 105 may be formed of a consumable and may be replaced over time due to wear. In some examples, the fan seal 105 may include a hard wall with an O-ring or a squishy seal.

The fan seal 105 may include a blade seal configured to provide a seal and/or reduce a clearance between an outer diameter of the blade fan 103 and an inner diameter of the duct 101. The fan seal 105 may be configured to be abraded by the blade fan 103 during operation of the fan propulsor 100. The fan seal 105 may include an abradable member configured such that, after an amount of operation of the fan propulsor 100, a groove is formed on the abradable member that is concentric with an outer diameter of the blade fan 103. In some examples, the fan seal 105 may include a support structure formed of a CTE (Coefficient of Thermal Expansion)-matched material configured to resist formation or enlargement of one more gaps between the blade fan 103 and the fan seal 105 due to temperature variation. The fan seal 105 may include one or more of: a flat sealing surface, a lip seal, a knife seal, a labyrinth seal, and a lift-off seal.

Due to the low heat produced in the propulsor fan 100 (e.g., for an electric driven propulsor with no combustion), and due to the propulsor fan 100 including the fan seal 105, the fan seal 105 may be made of soft compliant materials with large cross sections. Alternatively, the fan seal may be made of harder seal materials with longer service life. The fan seal 105 may be made of a plurality of knife edges that collectively form the fan seal 105. The knife edges may have tortuous paths, trapezoidal seals, fractured seals, and the like. In some examples, the fan seal 105 may include an abradable material and the fan seal 105 may be initially “burned in” to obtain a tight fit of the fan seal 105 within a fan seal housing formed between the front inlet liner 101A and the intermediate liner 101B. For example, some abradable materials suitable for the fan seal 105 may include polyesters, elastomers, polyimides, and thermally sprayed abradable coatings. During operation, the propulsor fan 100 may deflect quite a bit as the aircraft is maneuvered and as thrust is modified, etc. Therefore, rigid seals may not work as well, and abradable seals offer performance benefits in used with the propulsor fan 100.

Still referring to FIG. 1, the stator 107 may include a plurality of stator blades. The stator 107 may include components other than or in additional to those shown in FIG. 1. In some configurations, the stator blades may extend radially from a housing of the motor 109. That is, the root of each blade may be connected to the housing of the motor 109 and the airfoil of the stator blade may extend outward away from the housing of the motor 109. In some examples, each blade may extend away from the housing of the motor 109 at an angle measured with respect to a reference line that extends perpendicular from a point on the housing of the motor 109 from which the stator blade extends.

In one example, the stator blades may conduct heat away from the motor 109. Since the stator blades contact the housing of the motor 109, air that passes over the stator blades dissipates heat generated by the motor 109. In some examples, the arrangement of the stator blades may also reduce noise generated by the blade fan 103 and may control thrust generated by the propulsor fan 100. The blade count of the stator blades may be selected so that the harmonics of the stator 107 cancel out harmonics of the blade fan 103. For ultrasonic fans, because of the localized low Reynolds number along the blade, those skilled in the art will appreciate that the blade fan 103 may include a plurality of blades that may be higher in count (i.e., total amount) than the stator blades for favorable acoustics. This may vary anywhere from 50% to 200% more blades for a particular set of design tones. In some examples, tips of the stator blades may be in contact with an inner surface of a housing of the stator 107. Thus, the stator blades are stationary. By contacting the stator blades with the inner surface of the stator housing, the position of each blade of the stator 107 may be static.

The nose cone 113 may be configured to modulate oncoming airflow behavior and to reduce aerodynamic drag. The nose cone 113 may also be configured with an impeller to aid in cooling air mass flow without contributing significantly to broadband or tonal noise. As shown in FIG. 1, the nose cone 113 may be disposed within the front inlet liner 101A of the modular duct 101 and may be connected to the bladed fan 103.

In some examples, the nose cone 113 may be configured to connect to the motor 109 with the hub 117 disposed between the nose cone 113 and the motor 109. The nose cone 113 may include a plurality of mounting holes on a rear surface of the nose cone 113. Fasteners (e.g., nuts and bolts, rivets, etc.) may be placed in the mounting holes to connect the nose cone 113 to a first end of the hub 117. As will be further described below, the fasteners may extend through the hub 117 and connect to a first end of the motor 109.

In some examples, the nose cone 113 may be conical in shape. However, the nose cone 113 can include any number of shapes and geometries without departing from the scope of the present disclosure. The nose cone 113 may include an opening (e.g., a hole or orifice) at a first end of the nose cone 113. As the blade fan 103 spins, air may be pulled through the opening in the nose cone 113 to cool the motor 109. In some examples, secondary mass flow may cool inner components, based at least in part on a size of the inner diameter of an opening in the nose cone 113. Those skilled in the art will appreciate that this diameter may be derived subject to thermal requirements of different electric motors and the air required to cool them at the most constraining condition, typically max continuous operation.

The motor 109 may be connected to the stator 107. For example, the motor 109 may be an electric motor. More specifically, the motor 109 may be a line replacement air-cooled electric motor.

In some examples, the motor 109 may include a housing that is cylindrical in shape. The housing of the motor 109 may include a cavity disposed between a first end and a second end. The cavity may extend from the first end towards the second end, but reaching the second end. In particular, the cavity may be configured to house the motor 109. That is, the motor 109 may be placed within the cavity of a motor housing. Thus, the shape and size of the cavity may be dependent on the shape and size of the motor 109. Since the motor 109 may be placed within the cavity and the motor 109 may be indirectly connected to the hub, the stator 107 also functions as a structural component to support the hub and other components of the fan propulsor 100.

In some examples, the motor 109 may include a center hub-driven motor. That is, a single motor 109 may be used to drive the propulsor fan 100. An example motor 109 of the propulsor fan 100 may be an electric motor. In some examples, the motor 109 may be a brushless electric motor or an electric ducted fan (EDF). However, other types of motors such as a gas motor or jet turbine may be used in the propulsor fan 100 in other examples. Generally, different motor types and sizes may be used depending on the application of the propulsor fan 100.

The tail cone 111 may be configured to be connected to the motor 109. The tail cone 111 may be disposed within the aft structure 101C. The tail cone 111 may be configured to produce a change of area relative to that at the stator 107 using the air exits the propulsor fan 100. The tail cone 111 may be made of metal such as aluminum or titanium or may be made of a composite such as carbon fiber.

The tail cone 111 may include a first end and a second end. For example, the first end may have a diameter that is greater than a diameter of the second end. The diameter of the tail cone 111 may differ across a length of the tail cone 111. As shown in FIG. 1, the diameter of the tail cone 111 may decrease from the first end (e.g., forward end) towards the second end (e.g., aft end).

The tail cone 111 may include a first end (i.e., an inlet) and a second end (i.e., an outlet). In some examples, the first end may have a diameter that may be greater than a diameter of the second end. The diameter of the tail cone 111 may vary across a length of the tail cone 1111. As shown in FIG. 1, the diameter of the tail cone 111 reduces from the forward, first end towards the aft, second end.

In some examples, the first end of the tail cone 111 may be configured to connect to the second end of the motor 109. Thus, the diameter of the first end of the tail cone 111 may substantially match a diameter of the second end of the motor 109. In some examples, the first end of the tail cone 111 may include a mounting surface that mates with the second end of the motor 109. The mounting surface may be attached to the motor 109 using fasteners, for example. However, other attachment mechanisms may be used in other examples.

The tail cone 111 may include a cavity formed through the length of the tail cone 111 starting from the first end to the second end. Shaping of the aft end of the tail cone 111 may be governed by exhausted secondary flow from the interior of the tail cone 111 with respect to the expansion of the jet following a blade fan and/or a stator, for example, the bladed disk and/or stator 107.

The electronic speed controller unit 115 may be disposed on an outer surface of the modular duct 101. The electronic speed controller unit 115 may be disposed within a case that is on the outer surface of the modular duct 101 as shown in FIG. 1. The electronic speed controller unit 115 may take in power and instructions from a pilot or computer and convert into a specific format so as to drive the motor 109 at a desired speed.

### Removal of Front Liner

FIG. 4A illustrates a cross-section view of the ducted propulsor fan 100 with a flange 400 connected to the front inlet liner 101A according to one example. As shown in FIG. 4A, the fan seal 105 may be positioned between the front inlet liner 101A and the intermediate liner 101B of the modular duct 101. In some examples, the front inlet liner 101A may be held in place using a flange 400. The flange 400 may be connected to the first end 201A of the front inlet liner 101A thereby securing the front inlet liner 101A to the modular duct 101. Thus, the front inlet liner 101A may be clamped in place between the flange 400 and the fan seal 105.

FIG. 4B illustrates a cross-section view of the ducted propulsor fan 100 and the removal of the front inlet liner 101A according to one example. To service the fan seal 105, the propulsor fan 100 may be optionally removed from the airframe of the aircraft. Alternatively, the propulsor fan 100 may be serviced while still connected to the airframe or other body, e.g., a leaf blower, that houses the propulsor fan.

The flange 400 may be removed or otherwise manipulated thereby allowing the front inlet liner 101A to be removed from the modular duct 101. For example, the front inlet liner 101A may slide outward, e.g., towards a forward end, from the inner cavity of the modular duct 101 in the direction indicated by the arrow 405 to remove the front inlet liner 101A from the modular duct 101.

According to some examples, some or all portions of the modular duct 101 may be provided as a cartridge for a propulsor fan 100. For example, a cartridge may include an aft liner, e.g., aft liner 101B, configured for placement in the aft end 102B of the duct 101, a forward liner, e.g., forward liner 101A, configured for placement in the forward end 102A of the duct 101, and a fan seal, such as seal 105, positioned between the forward liner 101A and the aft liner 101B and facing an outer diameter of a fan 103, such that removal of the forward liner 101A enables access to at least the fan seal 105 from the first end 102A of the duct 101.

In some examples, the fan seal 105 may be permanently bonded with the forward liner 101A or with the aft liner 101B (or otherwise integral to a cartridge or other structure that comprises both the fan seal 105 and one of the forward liner 101A or the aft liner 101B). In some examples, a seal ring 105C may be positioned between the forward liner 101A and the aft liner 101B, and the fan seal 105 may be bonded to the seal ring 105C. The fan seal 105 may include a seal backer 105A and an abradable surface 105B proximate to the outer diameter of the blade fan 103. As described herein, the forward liner 101A may be configured to attach to the duct 101 using a plurality of tabs and slots.

FIG. 4C illustrates a cross-section view of the ducted propulsor fan 100 with the front inlet liner 101A removed from the ducted propulsor fan according to one embodiment. With the front inlet liner 101A removed, an opening 401 may be formed which allows for removal of the fan seal 105. A new fan seal may be installed once the old fan seal 105 is removed. For example, a jig may be used to concentrically align and press the seal into place. The front inlet liner 101A, may then be installed back into the modular duct 101. Certain embodiments, therefore, allow the non-destructive removal and reuse of liners, such as for example, front inlet liner 101A, shown in FIGS. 4A and 4B during installation of a new fan seal (e.g., fan seal 105) or portion thereof. Certain embodiments allow the removal and replacement of the fan seal 105 or portion thereof while the propulsor remains affixed to an airframe. Certain embodiments may even allow the propulsor to remain in its normal configuration, such as not requiring the propulsor from being rotated or otherwise configured in a non-flight condition with respect to its orientation while installing a new fan seal. If the propulsor fan 100 was removed from the airframe, the propulsor fan 100 may then be reinstalled in the airframe. Due to the removable front inlet liner 101A, the fan seal 105 may be quickly switched out, for example, within 30 minutes from when the front inlet liner 101A is removed, in examples described herein. Accordingly, ease of maintenance and repair of fan seals or other components in the fan propulsor may be significantly improved.

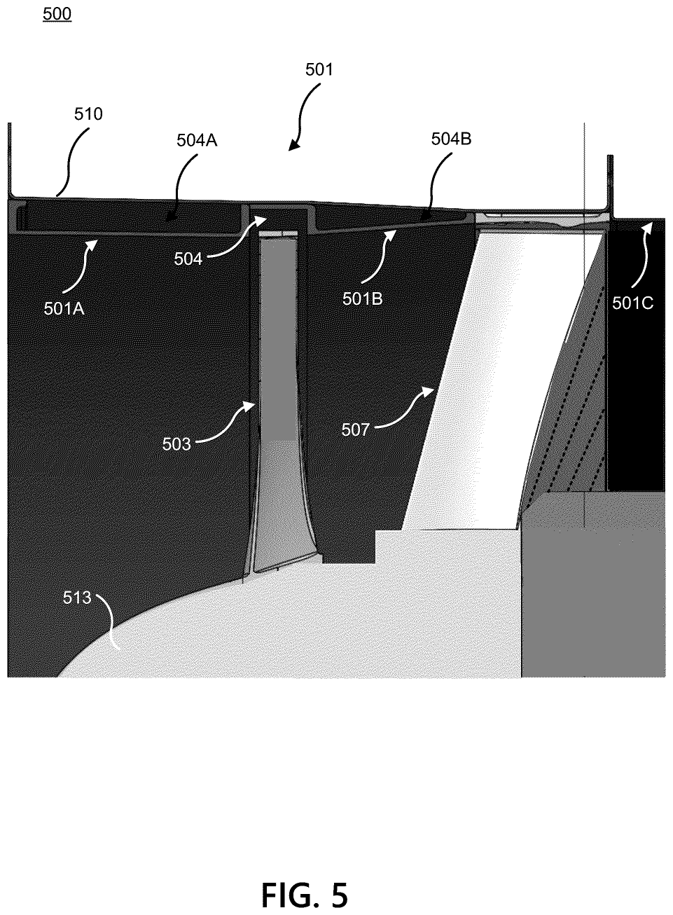

FIG. 5 illustrates another cross-section view of an upper, forward portion of a ducted propulsor fan 500 according to one or more examples. Like propulsor fan 100, the propulsor fan 500 may include a modular duct 501. A first liner or front inlet liner 501A of the modular duct 501 may be removable to allow for easier servicing of the propulsor fan 500 compared to conventional propulsor fans. The propulsor fan 500 may include a modular duct 501, a bladed fan 503, a fan gap section 504, a stator 507, a motor (not shown), and a nose cone 513, as well as a tail cone (not shown) and an electronic speed controller unit (not shown), among other components.

The propulsor fan may include an acoustic liner (e.g., forward liner) configured to attenuate noise, as will be described in more detail herein. As shown in FIG. 5, modular duct 501 may include a forward liner 501A (e.g., a first liner or a front inlet liner) at a first end (e.g., a forward end) of the modular duct 501, and an aft liner 501B (e.g., a second liner or an intermediate liner) at a second end (e.g., an aft end) of the modular duct 501. An aft structure 501C may be located aft of the aft liner, e.g., aft of the stator 507. The aft structure 501C may extend further aft of the propulsor fan 500 than what is shown in FIG. 5, e.g., and may extend to an aft end of the propulsor fan 500. The aft liner 501B may be located at an end, e.g., an aft end, of the forward liner 501A and may be located between the forward liner 501A and the aft structure 501C. The aft structure 501C may include an exhaust of the propulsor fan 500 (not shown in FIG. 5). The aft structure 501C may be separated from the aft liner 501B by the stator 507. In some examples, the aft structure 501C may be connected to an end, e.g., an aft end, of the aft liner 501B. While only a portion of the aft structure 501C is shown in FIG. 1, the aft structure 501C may extend to an aft end of the propulsor fan, and aft structure 501C may maintain a generally same cross-sectional area over a length thereof, or may taper towards the aft end of the propulsor fan 500.

As shown in FIG. 5, a forward end of the aft liner 501B includes a change in cross section area to form the fan gap section 504 between an outer diameter of the bladed fan 503 and the modular duct 501. In some examples, the forward liner 501A may include an area that forms the fan gap section 504. Still, in some examples, a portion of the forward liner 501A and a portion of the aft liner 501B may each include an area that forms the fan gap section 504. A forward duct space 504A may be formed between the forward liner 501A and an outer diameter wall 510 of the propulsor fan 500. An aft duct space 504B may be formed between the aft liner 501B and an outer diameter wall 510 of the propulsor fan 500. In some examples, a relatively large air gap may be formed at forward duct space 504A and/or aft duct space 504B, which may be filled with one or more acoustic features. In some examples, an aft end of the forward liner 501A may detachably couple to a forward end of the aft liner 501B using any suitable coupling mechanisms, such as tabs and slots, fasteners (e.g., nuts, bolts, rivets) and mounting holes, releasable flanges, and the like. For example, the cartridge may have a backing ring with tabs that engage the liners and that can float radially. In some examples, tabs and slot may hold other portions of the modular duct in place. In some examples, the aft liner 501B may be permanently or semi-permanently affixed to the propulsor fan 500. In some examples, the aft liner 501B may be configured to be removably coupled to the modular duct 501, e.g., in a similar manner as the forward liner 501A.

The forward liner 501A may be configured to provide a clean inflow of air to the propulsor fan 500. The forward liner 501A may form an inner liner of the modular duct 501 and may be non-structural. The forward liner 501A may be removable from an inner cavity of the modular duct 501 to allow for different front inlet liners to be installed in the modular duct 501. In that regard, the propulsor fan 500 may be configured to receive a plurality of different front inlet liners that may each have different structural characteristics. For example, a customer may want a propulsor fan with a smaller intake diameter than a current configuration of the propulsor fan 500. Thus, a front inlet liner that provides a smaller effective intake diameter than the currently installed forward liner 501A can be installed into the modular duct 501 without modifying the duct itself via traditional methods. Accordingly, the modular duct 501 may be compatible with a plurality of different front inlet liners. Further, other portions of the modular duct, such as the aft liner 501B or aft structure 501C, may be removable and replaceable with other components that may achieve different performance characteristics. Along similar lines, cartridges or cartridge portions, e.g., of varying sizes and configurations, may be easily fabricated and replaced on the fan propulsor. Some non-limiting examples include but are not limited to: a customer wanting an inlet liner (501A and/or 501B) replaced with one that has an acoustic treatment that reduces noise at a distance, or a customer wanting to replace a liner (501A and/or 501B) with a new one if the original item shows signs of wear or damage. Depending on different uses, propulsor fan 500 may be fitted with a liner such as, for example, an aft liner (e.g., 501B) that has a generally circular cross section or replaced with a different aft liner that results in section 501C to have a more non-circular cross-section. In one embodiment, for example, a cross-section of at least a portion of aft structure 501C may resemble a more oval cross section. In yet another embodiment, it may be replaced with an aft liner that results in at least a portion of aft structure 501C comprising a more rectangular cross-section. In one embodiment, a first aft liner is replaced with a second aft liner, in which the second aft liner is substantially reduced with respect to a height or width parameter when compared to the first aft liner. In certain embodiments, a first aft liner may be replaced with a second after liner, in which the second aft liner is reduced/expanded by a first ratio with respect to one of a height or width parameter when compared to the first aft liner and second aft is further reduced/expanded by a second ratio with respect to the other of the height or width when compared to the parameters of the first aft liner.

The forward liner 501A may include features similar to the features of front inlet liner 101A of FIGS. 2A, 2B, and 3. Similarly, the bladed fan 503, nose cone 513, motor, and stator 507 may include features similar to the bladed fan 103, nose cone 113, motor 109, and stator 107, respectively, of FIG. 1.

Though not shown in FIG. 5, a fan seal may be disposed along an outer circumference of the bladed fan 503 in the fan gap section 504. The fan seal may be the same as or similar to the fan seal 105 discussed above. The fan seal may be configured to reduce rotor tip leakage in the modular duct 501, thereby reducing noise and increasing efficiency. The fan seal may provide higher power efficiency due to the fan seal forcing the bladed fan 503 to intake new air rather than recirculating air, which also increases thermal efficiency. The fan seal may be formed of a consumable and may be replaced over time due to wear, e.g., the fan seal may be configured to be abraded by the fan.

As the removable forward liner 501A allows for ease of access to the fan gap section 504, the fan seal may be easily accessed and replaced. Still further, differing fan seals may be easily added or replaced in the fan propulsor, e.g., based on desired performance characteristics. For example, if the propulsor fan 500 is an electric driven propulsor with no combustion, then in one embodiment, a fan seal composed of soft, compliant materials and having a larger cross section may achieve more optimal performance characteristics than less compliant materials and/or a smaller cross section. Regardless of fuel or energy source, a propulsor configured to have a rotor with a certain quantity of blades and/or rotate at a certain RPM may be comprised of different materials than a propulsor with different characteristics. As another example, if the propulsor fan 500 is a combustion driven propulsor, then the fan seal may be composed of harder, stiffer materials to achieve longer service life. In some examples, the fan seal may intentionally include an abradable material and/or a quantity, density, or length of abradable material(s) configured to be initially “burned in” to obtain a tight fit within the fan gap section 504. During operation, the propulsor fan 500 may deflect considerably, such that abradable and/or flexible fan seal components may offer performance benefits. In certain embodiments, the material(s) of the seal are chosen, at least in part, due to the flexibility of the overall seal to prevent damage to the rotor when it moves out of its designed position.

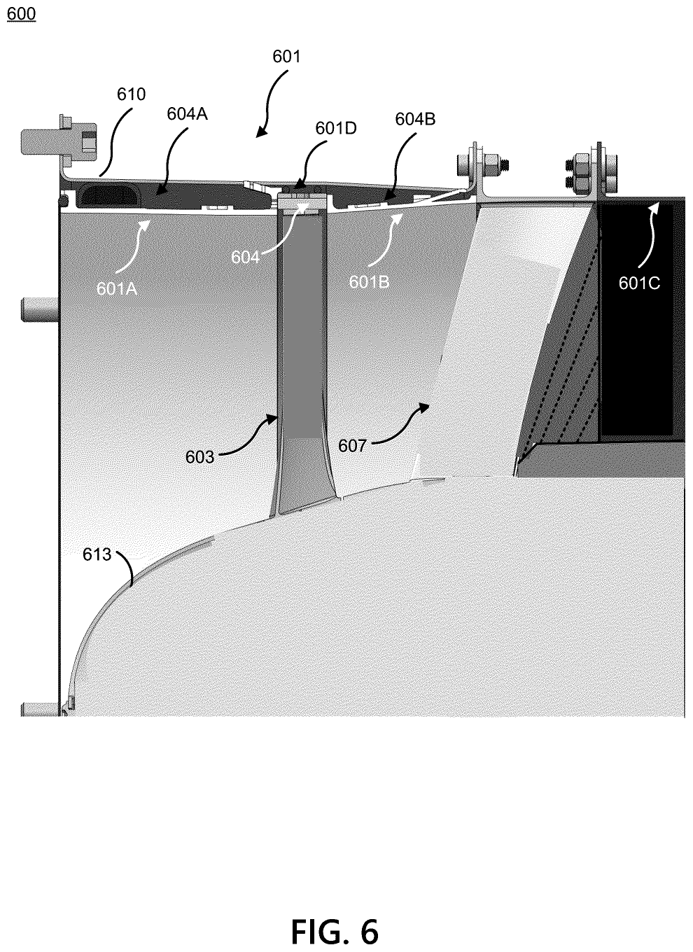

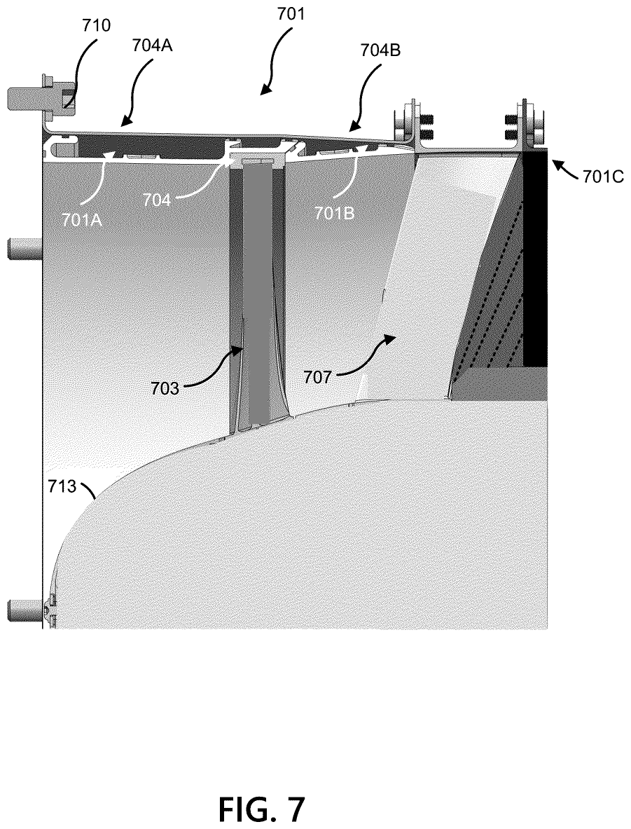

Further aspects of the present disclosures relate to multi-part modular liners. FIG. 6 illustrates a cross-section view of a ducted propulsor fan with a three-part modular ducted liner according to one or more examples as described herein. While a three-part liner is depicted, those skilled in the art with the benefit of this disclosure will appreciate that that more or less parts may be utilized in accordance with different embodiment (as one example, FIG. 7 illustrates an example showing two-parts). The three-part modular ducted liner, while having more parts (and thus relatively more complexity than other single part embodiments), may further facilitate fit and seal in the duct, which may result in noise reductions and more efficient propulsion. The modular ducted liner may include an acoustic liner configured to attenuate noise, as will be described in more detail herein. Like propulsor fan 100 and propulsor fan 500, the propulsor fan 600 may include a modular duct 601. The modular duct 601 may include a first liner 601A (e.g., a forward liner or a front inlet liner) at a first end (e.g., a forward end) of the modular duct 601, and a second liner 601B (e.g., an aft liner or an intermediate liner) at a second end (e.g., an aft end) of the modular duct 601. An aft structure 601C may be located aft of the second liner 601B, e.g., aft of the stator 607. A first liner 601A of the modular duct 601 may be removable to allow for easier servicing of the propulsor fan 600 compared to conventional propulsor fans. Also like propulsor fan 100 and propulsor fan 500, the propulsor fan 600 may include a bladed fan 603, a fan seal 604, a stator 607, a motor (not shown), and a nose cone 613, as well as a tail cone (not shown) and an electronic speed controller unit (not shown), among other components.

The second liner 601B may be located at an end, e.g., an aft end, of the modular duct 601 and may be located between the first liner 601A and the aft structure 601C. With the three-part modular ducted liner, a seal 610D (such as an O-ring for example) may be provided between the first liner 601A and the second liner 601B and may house or otherwise retain a fan seal 604 between an outer diameter of the bladed fan 603 and the modular duct 601. For ease of reading, seal 601D will be referred to as O-ring 601D to highlight certain embodiments, however, those skilled in the art will appreciate that not all embodiments are required to be an O-ring. The O-ring 601D may be used to center and retain the seal in duct 601. In some examples, O-ring 601D and fan seal 604 may be coupled together and provided to the propulsor fan 600 as a single unit. In some examples, the O-ring 601D may have a backing ring with tabs that engage the second liner 601B. In some examples, the second liner 601B may be radially positioned with the O-ring 610D when assembled in the propulsor fan 600. In accordance with certain embodiments, a seal backing ring material may be characterized by one or more of the following: able to be clamped between the forward and aft liners without deforming, be relatively stiff such that it can hold the foam seal material in the correct shape, and be the same (or nearly the same) alloy as the blades such that they have the same thermal growth properties.

The aft structure 601C may include an exhaust of the propulsor fan 600 (not shown in FIG. 6). As shown in FIG. 6, the aft structure 601C may be separated from the second liner 601B by the stator 607. In some examples, the aft structure 601C may be connected to an end, e.g., an aft end, of the second liner 601B. While only a portion of the aft structure 601C is shown in FIG. 6, the aft structure 601C may extend to an aft end of the propulsor fan 600, and aft structure 601C may maintain a generally same cross-sectional area over a length thereof, or may taper towards the aft end of the propulsor fan 600.

A first duct space 604A may be formed between the first liner 601A and an outer diameter wall 610 of the propulsor fan 600. A second duct space 604B may be formed between the second liner 601B and an outer diameter wall 610 of the propulsor fan 600. In some examples, a relatively large air gap may be formed at first duct space 604A and/or second duct space 604B, which may be filled with one or more acoustic features. In some examples, an aft end of the first liner 601A may detachably couple to a forward end of O-ring 601D using suitable coupling mechanisms, such as tabs and slots, fasteners (e.g., nuts, bolts, rivets) and mounting holes, releasable flanges, and the like. Similarly, an aft end of O-ring 601D may detachably couple to a forward end of the second liner 601B using similar suitable coupling mechanisms. In some examples, the second liner 601B may be permanently or semi-permanently affixed to the propulsor fan 600. In some examples, the second liner 601B may be configured to be removably coupled to the modular duct 601, e.g., in a similar manner as the forward liner 601A.

The first liner 601A may be removable from an inner cavity of the modular duct 601 to allow for access to the fan seal 604. Similarly, the O-ring 601D (along with the fan seal 604, in at least some examples), may be removable from the modular duct 601, to facilitate the replacement of a fan seal and/or to provide access to internal components of the propulsor fan 600. Further, other portions of the modular duct, such as the second liner 601B or aft structure 601C, may be removable and replaceable with other components that may achieve different performance characteristics. Along similar lines, cartridges or cartridge portions, e.g., of varying sizes and configurations, may be easily fabricated and replaced on the fan propulsor 600.

A fan seal 604 may be disposed along an outer circumference of the bladed fan 603 and the inner circumference of the O-ring 601D in the fan seal 604. The fan seal 604 may be configured to reduce rotor tip leakage in the modular duct 601, thereby reducing noise and increasing efficiency. The fan seal 604 may provide higher power efficiency due to the fan seal forcing the bladed fan 603 to intake new air rather than recirculating air, which also increases thermal efficiency. The fan seal 604 may be formed of a consumable and may be replaced over time due to wear, e.g., the fan seal may be configured to be abraded by the fan 603.

As the removable first liner 601A and O-ring 601D allows for ease of access to the fan seal 604, e.g., so that the fan seal 604 may be easily accessed and replaced. Still further, differing fan seals may be easily added or replaced in the fan propulsor, e.g., based on desired performance characteristics, as described herein, e.g., as similarly described with respect to FIGS. 1-5.

FIG. 7 illustrates a cross-section view of a ducted propulsor fan with a two-part modular ducted liner according to one or more examples as described herein. The two-part modular ducted liner, has less parts (and thus relatively less complexity) than the three-part configuration, and may allow for easier inspect and replaceability of parts therein. Like propulsor fans 100, 500, and 600, the propulsor fan 700 may include a modular duct 701. The modular duct 701 may include a first liner 701A (e.g., a forward liner or a front inlet liner) at a first end (e.g., a forward end) of the modular duct 701, and a second liner 701B (e.g., an aft liner or an intermediate liner) at a second end (e.g., an aft end) of the modular duct 701. An aft structure 701C may be located aft of the second liner 701B, e.g., aft of the stator 707. A first liner 701A of the modular duct 701 may be removable to allow for easier servicing of the propulsor fan 700 compared to conventional propulsor fans. Also like propulsor fans 100, 500, and 600, the propulsor fan 700 may include a bladed fan 703, a fan seal 704, a stator 707, a motor 709, and a nose cone 713, as well as a tail cone (not shown) and an electronic speed controller unit (not shown), among other components.

The second liner 701B may be located at an end, e.g., an aft end, of the modular duct 701 and may be located between the first liner 701A and the aft structure 701C. With the two-part modular duct 701 shown in FIG. 7, an aft portion of the first liner 701A may house or retain the fan seal 704 between an outer diameter of the bladed fan 703 and the modular duct 701. In some examples, the first liner 701A and fan seal 704 may be coupled together and provided to the propulsor fan 700 as a single unit. The aft structure 701C may include an exhaust of the propulsor fan 700 (not shown in FIG. 7). As shown in FIG. 7, the aft structure 701C may be separated from the second liner 701B by the stator 707. In some examples, the aft structure 701C may be connected to an end, e.g., an aft end, of the second liner 701B. While only a portion of the aft structure 701C is shown in FIG. 7, the aft structure 701C may extend to an aft end of the propulsor fan 700, and aft structure 701C may maintain a generally same cross-sectional area over a length thereof, or may taper inward towards the aft end of the propulsor fan 700.

A first duct space 704A may be formed between the first liner 701A and an outer diameter wall 710 of the propulsor fan 700. A second duct space 704B may be formed between the second liner 701B and an outer diameter wall 710 of the propulsor fan 700. In some examples, a relatively large air gap may be formed at first duct space 704A and/or second duct space 704B, which may be filled with one or more acoustic features. In some examples, an aft end of the first liner 701A may detachably couple to a forward end of the second liner 701B using suitable coupling mechanisms, such as tabs and slots, fasteners (e.g., nuts, bolts, rivets) and mounting holes, releasable flanges, and the like. Detaching the first liner 701A from the second liner 701B may allow for access to the fan seal 704 and/or other internal components. In some examples, the second liner 701B may be permanently or semi-permanently affixed to the propulsor fan 700. In some examples, the second liner 701B may be configured to be removably coupled to the modular duct 701, e.g., in a similar manner as the forward liner 701A.

The first liner 701A may be removable from an inner cavity of the modular duct 701 to allow for access to the fan seal 704, to facilitate the replacement of a fan seal and/or to provide access to other internal components of the propulsor fan 700. Further, other portions of the modular duct, such as the second liner 701B or aft structure 701C, may be removable and replaceable with other components that may achieve different performance characteristics. Along similar lines, cartridges or cartridge portions, e.g., of varying sizes and configurations, may be easily fabricated and replaced on the fan propulsor 700.

A fan seal 704 may be disposed along an outer circumference of the bladed fan 703 and the inner circumference of the first liner 701A. The fan seal 704 may be configured to reduce rotor tip leakage in the modular duct 701, thereby reducing noise and increasing efficiency. The fan seal 704 may provide higher power efficiency due to the fan seal forcing the bladed fan 703 to intake new air rather than recirculating air, which also increases thermal efficiency. The fan seal 704 may be formed of a consumable and may be replaced over time due to wear, e.g., the fan seal may be configured to be abraded by the fan 703. As the removable first liner 701A allows for ease of access to the fan seal 704, the fan seal 704 may be easily accessed and replaced. Still further, differing fan seals may be easily added or replaced in the fan propulsor, e.g., based on desired performance characteristics, as described herein, e.g., as similarly described with respect to FIGS. 1-6.

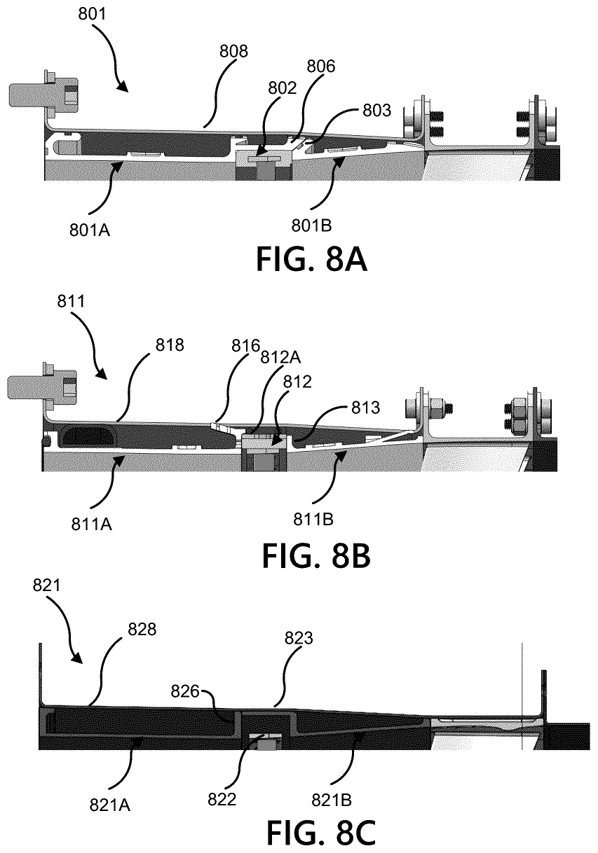

FIGS. 8A-8C illustrate cross-section views of a two-part modular ducted liner, a three-part modular ducted liner, and another two-part modular ducted liner, respectively, each mounted in a ducted propulsor fan according to one or more examples as described herein. FIGS. 8A-8C highlight various structural differences in modular liner connections and configurations amongst the various configuration options.

As shown in the two-part modular ducted liner 801 of FIG. 8A, which is similar to the modular ducted liner 701 of FIG. 7, the modular duct 801 may include a first liner 801A at a first end (e.g., a forward end) and a second liner 801B (e.g., an aft liner or an intermediate liner) at a second end (e.g., an aft end) that are both positioned on an interior side of the outer diameter wall 808 of a fan duct. Similar to the modular duct 701 of FIG. 7, the first liner 801A of the modular duct 801 may be removable to allow for easier servicing of the propulsor fan. With the two-part modular ducted liner 801 shown in FIG. 8, an aft portion of the first liner 801A may house or retain the fan seal 802 between an outer diameter of the fan and the modular duct 801. As shown in FIG. 8A, an aft flange 806 of the first liner 801A may detachably couple to a forward flange 803 of the second liner 801B using suitable coupling mechanisms, such as tabs and slots, fasteners (e.g., nuts, bolts, rivets) and mounting holes, releasable flanges, and the like. As the fan seal 802 is housed or retained by an aft portion of the first liner 801A, such that removal of the first liner 801A, e.g., by decoupling the aft flange 806 from the forward flange 803, provides access for the fan seal 802. The fan seal 802 may be formed of a consumable and may be replaced over time due to wear, e.g., the fan seal may be configured to be abraded by the fan.

As shown in the three-part modular ducted liner 811 of FIG. 8B, which is similar to the modular ducted liner 601 of FIG. 6, the modular duct 811 may include a first liner 811A at a first end (e.g., a forward end), a second liner 811B (e.g., an aft liner or an intermediate liner) at a second end (e.g., an aft end), and a fan seal liner 812A that are each positioned on an interior side of the outer diameter wall 818 of a fan duct. Similar to the modular duct 601 of FIG. 6, the first liner 811A of the modular duct 811 may be removable to allow for easier servicing of the propulsor fan. With the three-part modular ducted liner 811 shown in FIG. 8B, the fan seal liner 812A may house or retain the fan seal 812 between an outer diameter of the fan and the modular duct 811. As shown in FIG. 8B, an aft flange 816 of the first liner 811A may detachably couple to a portion, e.g., a forward edge, of the fan seal liner 812A, and a forward flange 813 of the second liner 811B and couple to a portion, e.g., an aft edge of the fan seal liner 812A, with both coupling using suitable coupling mechanisms, such as tabs and slots, fasteners (e.g., nuts, bolts, rivets) and mounting holes, releasable flanges, and the like. As the fan seal 812 is housed or retained by the fan seal liner 812A between the first liner 811A and the second liner 811B, such that removal of the first liner 811A, e.g., by decoupling the aft flange 816 from the fan seal liner 812A, provides access for the fan seal 812.

As shown in the two-part modular ducted liner 821 of FIG. 8C, which is similar to the modular duct 501 of FIG. 5, the modular duct 821 may include a first liner 821A at a first end (e.g., a forward end) and a second liner 821B (e.g., an aft liner or an intermediate liner) at a second end (e.g., an aft end) that are both positioned on an interior side of the outer diameter wall 828 of a fan duct. Similar to the modular duct 501 of FIG. 5, the first liner 821A of the modular duct 821 may be removable to allow for easier servicing of the propulsor fan. With the two-part modular ducted liner 821 shown in FIG. 8C, an aft portion of the first liner 821A may house or retain the fan seal 822 between an outer diameter of the fan and the modular duct 821. As shown in FIG. 8C, an aft flange 826 of the first liner 821A may detachably couple to a forward flange 823 of the second liner 821B using suitable coupling mechanisms, such as tabs and slots, fasteners (e.g., nuts, bolts, rivets) and mounting holes, releasable flanges, and the like. As the fan seal 822 is housed or retained by a forward portion of the first liner 821A, such that removal of the first liner 821A, e.g., by decoupling the aft flange 826 from the forward flange 823, provides access for the fan seal 822. As the fan seal 822 may be housed or retained by the second liner 821B, additional steps beyond removal of the first liner 821A may be performed to replace the fan seal 822, such as loosening or otherwise adjust the forward flange 823 of the second liner 821B.

### Method of Servicing a Fan Propulsor

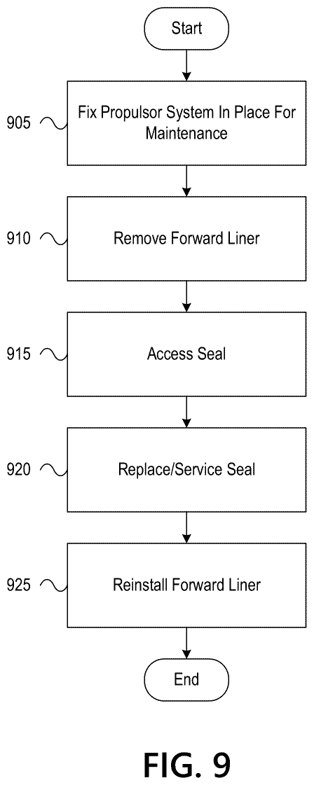

FIG. 9 illustrates an example flow chart for performing maintenance on a ducted propulsor fan with a modular duct and liner cartridge according to one or more examples as described herein.

At step 905, a propulsor system may be fixed in place for maintenance. In some instances, this step may include removing the propulsor system from the airframe or other body, while in some instance, this step may include fixing the airframe or other body in place and not removing the propulsor system therefrom. At step 910, a forward liner (such as an example forward liner disclosed herein) may be removed from the propulsor system thereby providing access to a seal positioned aft of the forward liner. As described herein removal of the forward liner at step 910 may include decoupling fasteners or other suitable coupling means between the forward liner and other portions of the duct. In some examples, step 910 may include removing the forward liner from a forward end of a fan duct of the propulsor fan. At step 915, the fan seal may be accessed after removal of the forward liner. As discussed with respect to the various configurations discussed herein, the fan seal may remain in position in the propulsor system but positioned for access via a front side of the propulsor system upon removal of the front liner. In some configurations, additional portions of the propulsor system may be removed or repositioned, once the front liner is removed to access the fan seal. Once the fan seal is accessed, at step 920, the fan seal may be serviced or replaced as needed for maintenance and operability of the propulsor system. Step 920 may include removing the seal from an installation location in the propulsor fan and installing a new fan seal at the installation location and centering the new fan seal in place in the propulsor system. Subsequently, at step 925, the forward liner may be reinstalled on the propulsor system to return the propulsor system to operation-ready condition. In some examples, reinstalling the forward liner at step 925 may include reinstalling the forward line in place in the forward end of the fan duct.

Accordingly, systems and apparatuses that include such removable cartridge liner and seal systems have a number of benefits and advantages including increased aerodynamic efficiency, reduced noise, and reduced cyclic loading, among other factors. For example, the fan seal may provide higher power efficiency to the propulsor fan by forcing the fan to intake new air rather than recirculating air, thereby also increasing thermal efficiency. Typical turbo engines may have fan seals replaced approximately every 1,000 to 10,000 hours. Traditional methods for fan seal replacement often require substantial time to access the fan seal as a stack of components must first be disassembled and/or removed in order to access the fan seal. Modular duct systems according to the present disclosure may thus allow for fan seals to be switched out easily and quickly. Additionally, for electric propulsors, such as those described herein, as there is no combustion, and the fan may have a tip shroud, the fan seal may be composed of lower-cost materials and may be made via lower-cost manufacturing processes (e.g., 3D printing, injection molding, bonding, polymer processes, etc.) as opposed to those associated with higher cost materials.

Modular cartridge liners/ducts as discussed herein provide a number of benefits, including ease of replacing components, such as the fan seal and liner portions (e.g., forward liner, aft liner). Removal of the cartridge liner/duct may also provide access to clean out debris, open fan tip clearances as need, alter configurations for multi-mission support, and the like.

Additionally, for electric-driven fan propulsors, the relatively lower heat produced by the fan, and the fan having a tip shroud, soft compliant materials having relatively large cross sections may be used for the fan seal, e.g., to better fit to a fan gap section with the fan and thereby improving performance metrics of the propulsor fan. Further, hard less-compliant materials may also be used to provide longer service life. Fan seals are described herein be include any number of shapes, including knife edges with tortuous paths, trapezoidal seals, and fractured seals. By using an abradable material for the fan seal, the fan seal may be “burned in” to initially provide an appropriate tight fit within a fan gap section with the fan. The rotor/fan may deflect as the propulsor maneuvers and/or as thrust varies. Thus, abradable seals have performance benefits over more rigid seals.

Additional benefits include that the fan seal may be directly installed from the front of the fan stage of the propulsor. For example, steps to replace a fan seal may include (1) removing the propulsor assembly from the airframe or other body; (2) removing the front liner/duct portion from the front end of the propulsor; (3) removing an existing (e.g., worn) fan seal; (4) installing a new fan seal, and optionally using a jig or other suitable tooling to concentrically align and press the fan seal into place in the propulsor assembly; (5) installing the front liner/duct portion (e.g., the same front liner/duct portion from step (2) or a modified front liner/duct portion if new performance characteristics are desired); and (6) installing the propulsor assembly back to the airframe or other body if removed for servicing.

Modular ducts/liners as discussed herein also have the benefit of allowing for easy access to the fan seal, fan, motor, and stators for allowing the front liner to be modular. Additionally, the liner may be non-structural (with the duct in which the liner is installed being structural) such that new or different fans or liner geometries may be installed without modifying the duct itself. Additionally, different liner geometries may be used to augment flow and acoustic properties of the fan propulsor. Additionally, such configurations allow for radial heaters to also be added in the duct space in the duct space between the liner and the duct, e.g., to prevent icing.

Modular ducts/liners in accordance with the present disclosure allow for easy replaceability during maintenance of the fan and other components. Such modular ducts/liners may move the center of gravity of the acoustic liner in a potentially useful manner, and the air seal with the modular duct/liner results in a quieter system with improved aerodynamics and a reduced air flow over the fan tips. Such systems are useful for propulsors having lower tip speeds and lower operating temperatures, in which more affordable (e.g., abradable) materials can be used. Where fan blades are relatively thin, the fan blade tips may include a shroud, such that fan seals are more useful, e.g., to prevent losses over the shroud. In some examples, the modular cartridge may be attached relative to the rotor rather than the duct and may be designed to be compliant with a position of the rotor. In that regard, the seal placement may be defined by the rotor rather than the duct. Additionally, fan seals and duct liners used in fan propulsors in accordance with the present disclosure may be passively tuned, and active control can be used but is not needed. In comparison to designs in which the duct includes a bump for a fan seal, and assembly of the fan seal in the duct is very difficult due to component geometries (e.g., sharp corners, joints, bends) and based on having to self-center and align the fan seal with the liner in the flow path. In some examples, the fan seal may be held in its own backing ring, e.g., in the three-piece configuration, so as to better match thermal growth of the line.

The cartridge modularity aspects as described herein provide benefits of customizing and allowing for easy design changes in a given propulsor. Different acoustic treatments may be applied as part of customizing a design. Sensors, such as static or pitot tubes, temperatures, or laser in frames may be added to the cartridge. Fan seals may be swapped easily during maintenance, which in electric fan propulsors may be performed passively due to the smaller relative temperatures and pressures, and allowing for acoustic optimization. A foam seal may be used for fan seals as described herein, which may have a lower life and made be changed at regular intervals. Depending on the intended utilization, a seal (e.g., a seal foam) may comprise material that fits one or more (or all) of the criteria of: (1) a relatively low hardness compared to the blade material so that when the materials contact, the seal is worn preferentially; (2) abrasion of the seal (including unintended failure) results in generally uniform particles that are not elongate, such as string-like particles; (3) not hygroscopic; and/or (4) be compliant so that when the blade and seal material come in to contact, the seal material compresses and/or is abraded. In one embodiment, the seal comprises or consists of open cell foam. In certain embodiments, the backing ring has generous cutouts such that, in combination with open cell foam or other materials with similar properties for porosity, prevents water pooling, which if unaddressed can turn into thick formations of ice when left out in the cold for long periods of time thereby posing a risk to surrounding components given that ice is destructive to the seal and potentially the rotor.

The cartridge may have one or more degrees of freedom relative to the propulsor. In some examples, a cartridge may be provided without a fan seal. In such examples, abradable sacrificial liners may be used with the cartridge and may be swapped regularly to provide enhanced repairability and modularity.

Although the subject matter has been described in language specific to structural features and/or methodological acts, it is to be understood that the subject matter defined in any statement of examples is not necessarily limited to the specific features or acts described above. Furthermore, while aspects of the present disclosure have been described in terms of preferred examples, and it will be understood that the disclosure is not limited thereto since modifications may be made to those skilled in the art, particularly in light of the foregoing teachings. For example, although various examples are described herein, features and/or steps of those examples may be combined, divided, omitted, rearranged, revised, and/or augmented in any desired manner. Various alterations, modifications, and improvements will be appreciated by those skilled in the art and are intended to be part of this description, even if not expressly stated herein, and are intended to be within the spirit and scope of the disclosures herein. The disclosures herein, therefore, are by way of example only, and are not limiting.

What is claimed is:

1. A propulsor fan configured to provide thrust comprising:
a duct extending from a first end to a second end;
a first liner configured to be removably installed at the first end of the duct;
a second liner proximate to the second end of the duct;
a fan positioned within the duct between the first liner and the second liner, wherein the fan is concentric with the first liner and the second liner; and
a seal positioned radially around the fan,
wherein removal of the first liner enables access to the seal from the first end of the duct.

2. The propulsor fan of claim 1, wherein the first liner comprises an acoustic liner configured to attenuate noise.

3. The propulsor fan of claim 1, wherein the seal is configured to be intentionally abraded by the fan during a first operation of the propulsor, wherein the intentional abrasion does not reduce the air-moving capabilities of the propulsion.

4. The propulsor fan of claim 1, wherein the first liner comprises a hoop shape that extends circumferentially around an inner diameter of the duct.

5. The propulsor fan of claim 1, wherein the second liner comprises a hoop shape that extends circumferentially around an inner diameter of the duct.

6. The propulsor fan of claim 1, wherein the seal comprises a blade seal configured to reduce a clearance between an outer diameter of the fan and an inner diameter of the duct.

7. The propulsor fan of claim 1, further comprising a plurality of tabs and a plurality of slots, each slot being configured to receive a respective tab, wherein the plurality of tabs and the plurality of slots are configured to releasably hold the first liner in place in the duct.

8. The propulsor fan of claim 1, wherein the seal comprises an abradable member configured to form, based on operation of the propulsor, a groove that is concentric with an outer diameter of the fan.

9. The propulsor fan of claim 1, wherein the seal comprises a support structure comprising CTE-matched material configured to resist formation or enlargement of one more gaps between the fan and the seal due to an ambient temperature variation.

10. The propulsor fan of claim 1, wherein the seal comprises one or more of: a flat sealing surface, a lip seal, a knife seal, a labyrinth seal, or a lift-off seal.

11. The propulsor fan of claim 1, wherein the first liner comprises a plurality of apertures in a region proximate to a tip of the fan, each aperture being configured to drain ingested water from an airflow path through the propulsor fan.

12. The propulsor fan of claim 11, wherein a semi-porous or cellular structure resides within one or more apertures of the plurality of apertures.

13. The propulsor fan of claim 1, wherein the first liner comprises a fan tip region that extends over an outer diameter of the fan, and wherein a diameter of the fan tip region is larger than a diameter of the first end of the first liner.

14. The propulsor fan of claim 1, further comprising a third liner between the first liner and the second liner, wherein the third liner extends over an outer diameter of the fan with respect to a cross-sectional plane along a length of the duct from the first liner and the second liner.

15. A cartridge for a propulsor fan comprising:
an aft liner configured for placement in an aft end of a duct of the propulsor fan;
a forward liner configured for placement in a forward end of the duct of the propulsor fan; and
a seal positioned between the forward liner and the aft liner and positioned radially around an outer diameter of a fan of the fan propulsor,
wherein removal of the forward liner enables access to the seal from the forward end of the duct.

16. The cartridge of claim 15, wherein the seal is bonded with the forward liner or with the aft liner.

17. The cartridge of claim 15, further comprising a seal liner between the forward liner and the aft liner, and wherein the seal is bonded to the seal liner.

18. The cartridge of claim 15, wherein the seal comprises a seal backer and an abradable surface proximate to the outer diameter of the fan.

19. The cartridge of claim 15, wherein the forward liner is configured to attach to the duct using a plurality of tabs and slots.

20. A method of servicing components of a fan propulsor, the method comprising:
removing a forward liner from a forward end of a fan duct of the propulsor fan thereby providing access to a seal positioned aft of the forward liner;
removing the seal from an installation location in the propulsor fan;
installing a new seal in the propulsor fan at the installation location; and
reinstalling the forward liner in the forward end of the fan duct.
